(19) United States
(12) Patent Application Publication
(10) Pub. No.: US 2011/0137809 A1
(43) Pub. Date: Jun. 9, 2011

(54) ESTABLISHING SECURE TUNNELS FOR CUSTOMER SUPPORT

(75) Inventor: Michael Scott Klapheke, Baldwinsville, NY (US)

(73) Assignee: CIMonitor, Inc., Baldwinsville, NY (US)

(21) Appl. No.: 12/958,908

(22) Filed: Dec. 2, 2010

Related U.S. Application Data
(60) Provisional application No. 61/266,341, filed on Dec. 3, 2009.

(51) Int. Cl. G06Q 10/00

(52) U.S. Cl. 705/304

(57) ABSTRACT

The present invention is directed to a method and apparatus of establishing a secure tunnel to provide customer support to a customer site. One example method of operating may include transmitting a help request from a customer device to a support server. The method may also include establishing a first portion of the communication tunnel between the customer device and the support server, transmitting credentials to a third party support worker device, and establishing a second portion of the communication tunnel between the third party support worker device and the support server based on the credentials.

### CROSS-REFERENCE TO RELATED APPLICATIONS

This invention claims priority to provisional application No. 61/266,341, filed on Dec. 3, 2009, entitled “SUPPORT TUNNEL OPERATION”, the entire contents of which are incorporated by reference.

### TECHNICAL FIELD OF THE INVENTION

This invention relates to a method and apparatus of establishing a secure tunnel between a customer a support server and a support worker to provide customer support to the customer.

### BACKGROUND OF THE INVENTION

A customer end user requires remote access to a support server and/or a third party support worker. The worker may respond to a customer's request or may perform routine maintenance procedures, upgrades, emergency monitoring, and other functions.

Conventionally, the user's computer platform or workspace would be consumed by the support connection established to the support worker. This requires time and computer resources that would require the customer to standby until the problems have been resolved or the upgrades and maintenance have been completed.

### SUMMARY OF THE INVENTION

One embodiment of the present invention may include a method of establishing a communication tunnel to provide customer support. The method may include transmitting a help request from a customer device to a support server, and establishing a first portion of the communication tunnel between the customer device and the support server. The method may also include transmitting credentials to a third party support worker device, and establishing a second portion of the communication tunnel between the third party support worker device and the support server based on the credentials.

Another example embodiment of the present invention may include an apparatus configured to establish a communication tunnel to provide customer support. The apparatus may include a transceiver configured to receive a help request from a customer device and forward the help request and customer credentials to a third party worker device. The apparatus may also include a processor configured to establish a first portion of the communication tunnel to the customer device and to establish a second portion of the communication tunnel to the third party support worker device based on the credentials.

### BRIEF DESCRIPTION OF THE DRAWINGS

FIG. 1 illustrates an example logic diagram of the virtual servers included in the appliance architecture, according to example embodiments of the present invention.

FIG. 2 illustrates an example network configuration of the end user, support server and support worker in communication with one another, according to example embodiments of the present invention.

FIG. 3 illustrates an example graphical user interface for requesting support, according to example embodiments of the present invention.

FIG. 4 illustrates another example network configuration of the end user, support server and support worker in communication with one another, according to example embodiments of the present invention.

FIG. 5 illustrates yet another example network configuration of the end user, support server and support worker in communication with one another, according to example embodiments of the present invention.

FIG. 6 illustrates another example network configuration of the end user, support server and support worker in communication with one another, according to example embodiments of the present invention.

FIG. 7 illustrates an example graphical user interface for establishing a tunnel, according to example embodiments of the present invention.

FIGS. 8 and 9 illustrate further example network configurations of the end user, support server and support worker in communication with one another, according to example embodiments of the present invention.

FIGS. 10A and 10B illustrate an example graphical user interfaces for opening a tunnel, according to example embodiments of the present invention.

FIGS. 11 and 12 illustrate example graphical user interfaces for requesting support, according to example embodiments of the present invention.

FIG. 13 illustrates an example graphical user interface once a connection has been established, according to example embodiments of the present invention.

FIG. 14 illustrates an example network entity that may store instructions and a processor and memory to execute those instructions based on example methods of operation of the present invention.

FIG. 15 illustrates a flow diagram of an example method of operation.

### DETAILED DESCRIPTION OF THE INVENTION

It will be readily understood that the components of the present invention, as generally described and illustrated in the figures herein, may be arranged and designed in a wide variety of different configurations. Thus, the following detailed description of the embodiments of a method, apparatus, and system, as represented in the attached figures, is not intended to limit the scope of the invention as claimed, but is merely representative of selected embodiments of the invention.

The features, structures, or characteristics of the invention described throughout this specification may be combined in any suitable manner in one or more embodiments. For example, the usage of the phrases “example embodiments”, “some embodiments”, or other similar language, throughout this specification refers to the fact that a particular feature, structure, or characteristic described in connection with the embodiment may be included in at least one embodiment of the present invention. Thus, appearances of the phrases “example embodiments”, “in some embodiments”, “in other embodiments”, or other similar language, throughout this specification do not necessarily all refer to the same group of embodiments, and the described features, structures, or characteristics may be combined in any suitable manner in one or more embodiments.

In addition, while the term “message” has been used in the description of embodiments of the present invention, the invention may be applied to many types of network data, such as packet, frame, datagram, etc. For purposes of this invention, the term “message” also includes packet, frame, datagram, and any equivalents thereof. Furthermore, while certain types of messages and signaling are depicted in exemplary embodiments of the invention, the invention is not limited to a certain type of message, and the invention is not limited to a certain type of signaling.

According to example embodiments of the present invention, a monitor appliance application (CIMonitor™) may be used to provide the status of the end user's security environment (e.g., video surveillance, access control servers, switches, etc.). An example component of the CIMonitor™ is a remote support tunnel. The support tunnel (“the tunnel”) provides a mechanism to initiate and control a secure connection, allowing individuals, such as, remote support or emergency responder personnel to access the customer's facilities. For example, remote access may include access to equipment and other assets, maintenance procedures, upgrades, emergency monitoring, and other functions.

The tunnel may be established and contained in a separate secure work environment. Such a configuration may free the support requesting user from using the requesting user's own workspace to host the support request. The support request may also be generated on-the-fly whenever needed, which alleviates time-consuming and expensive traditional virtual private network (VPN) solutions. Examples are described throughout this specification for the establishment and control of the support tunnel, its architecture, and its operation.

Certain definitions used throughout the specification are defined below.

End user—also known as the customer, the end user owns, rents, or, is otherwise in possession of the CIMonitor™ appliance.

Support person—this person is located anywhere in the world and may provide support to the end user.

Emergency responder—is typically located in the nearby vicinity of the end user and provides fire, police, ambulatory and other emergency services.

CIMonitor™ appliance—is an application responsible for tracking the health of an end user's physical security environment. It is located on the end user's network in one embodiment. It may include a hardware appliance and associated software. The software can utilize any kernel and operating system and may be a modified Debian Linux kernel running the main server (CIMonitor™ server) and/or two virtual servers (VServers).

VServers—are the node manager and the support manager, defined below.

CIMonitor™ node manager—is responsible for managing user interaction through a browser interface. It contains the customer database and provides the alerting and polling functions and also manages data from the CIMonitor™ probe manager for alerting and reporting purposes.

CIMonitor™ support manager—is responsible for establishing the support tunnel when support is requested, and connects to CIMonitor™ server for port assignment and to synchronize username/password pairs, and, also permits a connection to the GUI desktop (Linux GNOME/KDE or Windows Remote Desktop) for providing remote support. Further, it accepts TCP socket connections from the CIMonitor™ alert probe. When a socket connection is received by an alert probe, CIMonitor™ automatically opens a support tunnel and notifies the appropriate personnel. The specific notification parameters are uniquely programmed for each customer.

CIMonitor™ support server—is controlled by CIMonitor, Inc. It is centrally located, and allows a connection for the support/emergency responder to complete a tunnel to the end user. It also provides port assignment for tunnel creation and synchronizes the username/password pair from the support manager.

Alert probe—is a microcontroller-based device which can be located anywhere in a customer's network. Its functions are to receive a dry contact input from one or more alarm sources (burglar alarms, fire alarms, other sensors, etc,), and, upon receiving the input, send a specially crafted TCP message to the CIMonitor™ support manager. The CIMonitor™ support manager then opens an appropriate tunnel.

The CIMonitor™ support tunnel may be based on a client-server model. In operation, when an end user (the user) requests support, this request is sent via email or provided verbally to the support person. The notification permits the support person temporary access to the remote system using a separate, encrypted, self-contained work environment. In addition, tunnels can be automatically opened based on specific user-defined events, such as, the receipt message of an alarm input provided from a CIMonitor™ alert probe. Another example of automatic tunnel creation may be the result of a notification from the CIMonitor™ node manager that specific alert conditions have been met (e.g., a specific number of cameras are down, a specific number of door controllers are unavailable, etc.).

When the support person is finished, the tunnel can be closed, either automatically or manually, by the end user. The tunnel connection is encrypted, providing data confidentiality. The connection is also secure, providing rotating usernames and random passwords and non-repeating connection ports for each connection. Also, the connection may be built on-the-fly, which avoids time consuming setup requirements typical of most remote access scenarios. The connection is controlled by the end user (also known as the initiator or customer). The user can instantly terminate an individual support request or the entire support service function.

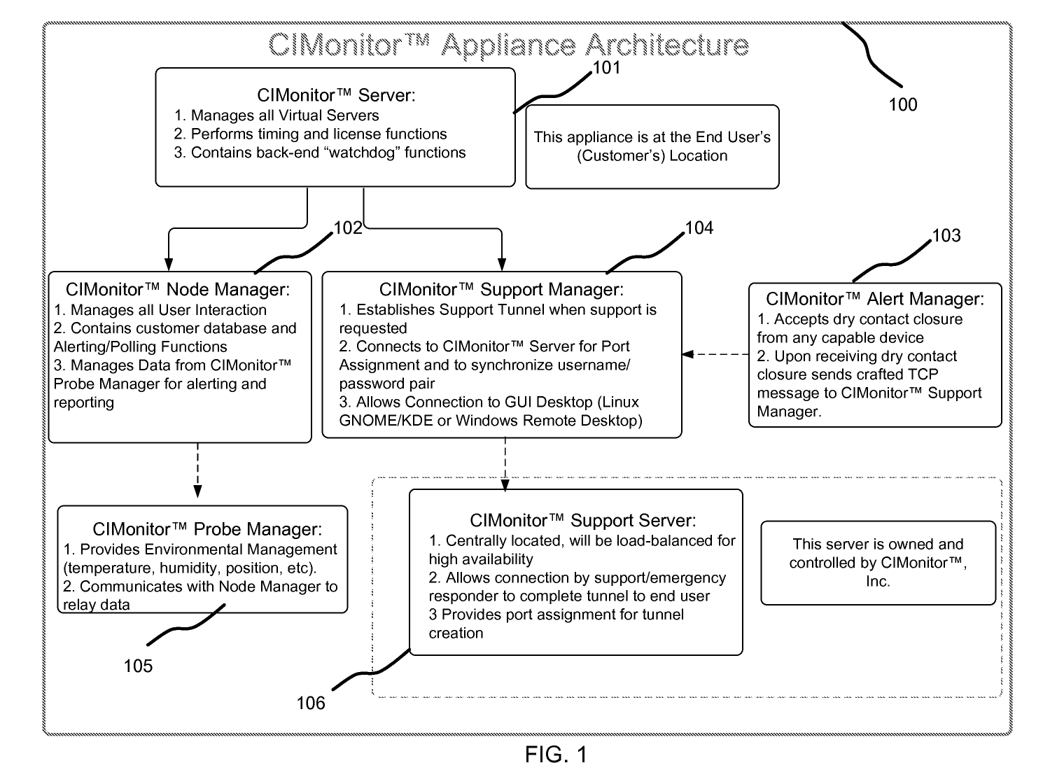

FIG. 1 illustrates an example logic diagram of the operations associated with the CIMonitor™ appliance architecture 100. CIMonitor™ appliance architecture illustrates the architecture of the CIMonitor™ appliance, which is based on a Debian Linux Server and multiple virtual servers (VServers). In the CIMonitor™ appliance, there are currently two (2) VServers, each used for specific tasks. The naming convention used for these servers and the associated tasks may include a CIMonitor™ server 101, which is the primary server or non-VServer, also called the host server.

The CIMonitor™ server 101 functions to provide startup operations (e.g., boot sequence, hardware interaction, etc.). Host VServers (also known as Guest Servers) provide timing and licensing verification functions. The CIMonitor™ server 101 may also act as a liaison between VServers. Since direct communication between VServers is not possible, the host server provides a mechanism to pass information between each VServer.

CIMonitor™ node manager 102 is the VServer that provides the command and control operation of the tunnel, as well as other functions required by CIMonitor™. Its functions may include user-facing activities as well as other functions of the CIMonitor appliance (e.g., alerting, reporting, etc). It may also host the web-based graphical user interface (GUI) for the end user. The node manager 102 contains the customer information database, and interacts with the CIMonitor™ probe manager 105, which is responsible for providing environmental and physical conditions to the node manager 102 for reporting and alerting conditions.

The CIMonitor™ support manager 104 is a VServer that initiates and terminates the tunnel, provides the pre-fetch operation (described below), and provides a separate work environment for the support of emergency responder personnel to work in. The support manager 104 also authenticates the support worker. Optionally, it can also route support requests to a Windows OS, either on the CIMonitor™ appliance or on another host.

The CIMonitor™ probe manager 105 provides environmental and other information directly to the node manager 102 via an Ethernet-based microcontroller which provides functions, such as, temperature sensing, humidity sensing, position sensing, etc. The node manager 102 is responsible for periodic polling of the probe manager 105 and displaying the results on the node manager GUI 102. The CIMonitor™ alert manager 103 is an Ethernet-based microcontroller that accepts dry contact input from one or more sources and sends specific TCP messages to the CIMonitor™ support manager 104, which then opens a support tunnel. The TCP ports can vary depending on the customer's existing network so no port conflicts are created.

The CIMonitor™ support server 106 can be located at any data center location. This central server provides the central point of connection for all remote support tunnels, and also provides the port that each connection can use, by utilizing a “pre-fetch” operation described below. Users initially connect to the CIMonitor™ support server 106, which is configured to allow the specific user to connect via SSH port-forward to the CIMonitor™ appliance requesting support. This SSH connection is limited to port-forwarding, and any attempt to run additional commands on the CIMonitor™ support server 106 results in immediate connection termination.

The support server 106 also includes an option for a high-availability load-balanced solution with multiple servers in different locations, in order to reduce the likelihood of having a single point of failure for establishing a tunnel. The functions that the support server 106 provides are the same regardless of whether one support server 106, or, multiple support servers are deployed. To support load balancing, a dedicated load balancer is used. The load balancer is not part of CIMonitor™ but supports typical load balancing features, such as, balancing servers based on server load and server health.

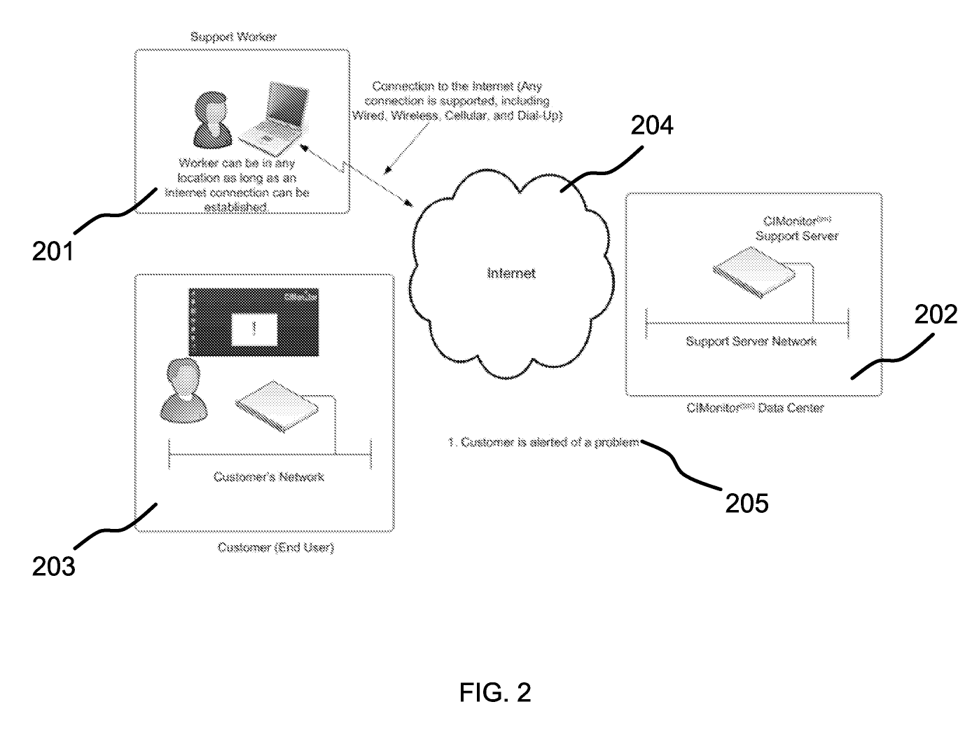

The CIMonitor™ application deployment will use load balancing in an active/failover capacity. If one server fails, requests will automatically be routed to an active server for fulfillment. Switchovers will remain transparent to the end user, since the load balancer will be the front-end for the requests. In operation, the CIMonitor™ connection flow may include a plurality of different procedures. For example, FIG. 2 illustrates an example network configuration, according to example embodiments of the present invention.

Referring to FIG. 2, a support worker 201, a customer 203 and support server 202 are illustrated as being in communication with one another via an Internet connection 204. At operation 205, a customer is alerted of a problem. The problem may be discovered by an automated support server 202 that monitors certain network attributes and operating conditions. In this example, when the problem is identified, there are no support tunnels open. As a result, the end user can perform one or more of the following tasks, such as, ignore the issue, respond to the issue directly, initiate a help request to allow an outside support person to provide remote support. If the last option is chosen, a communication tunnel may be created between the user 203 and the support server 202 and/or a third party support center 201.

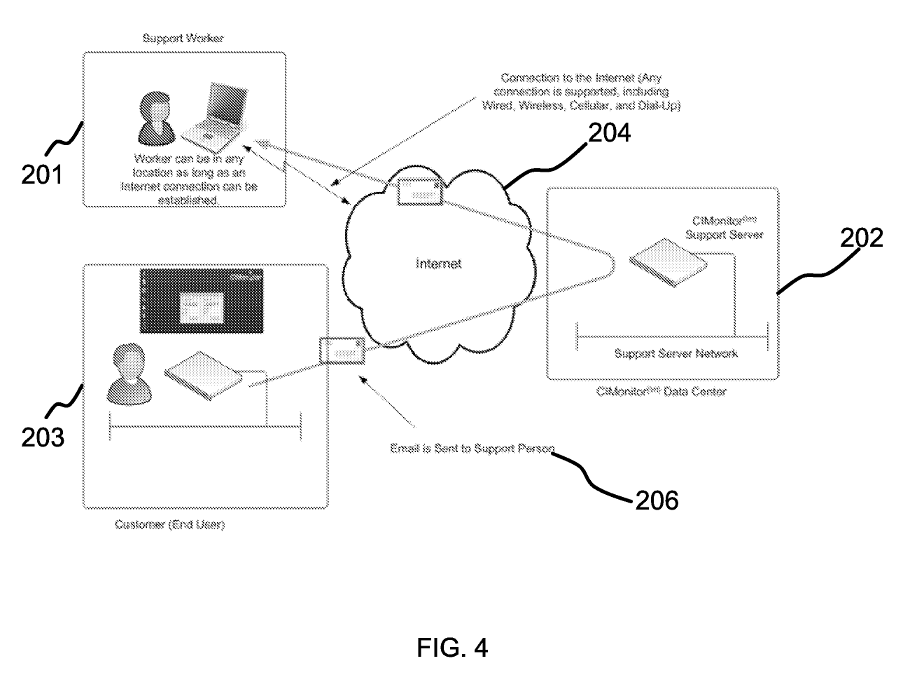

Once the help request has been initiated, the customer may access a CIMonitor™ appliance and initiate a support tunnel. An email or comparable communication message may be initiated automatically and sent to a support person, or, certain login credentials may be provided verbally. If the support person has an electronic pager, smartphone or other comparable communication device, the support person can be electronically paged as in operation 206 of FIG. 4.

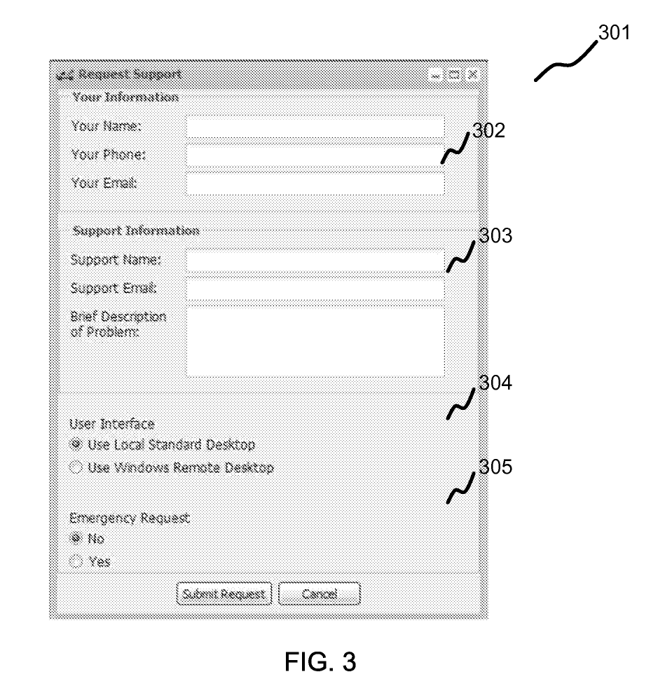

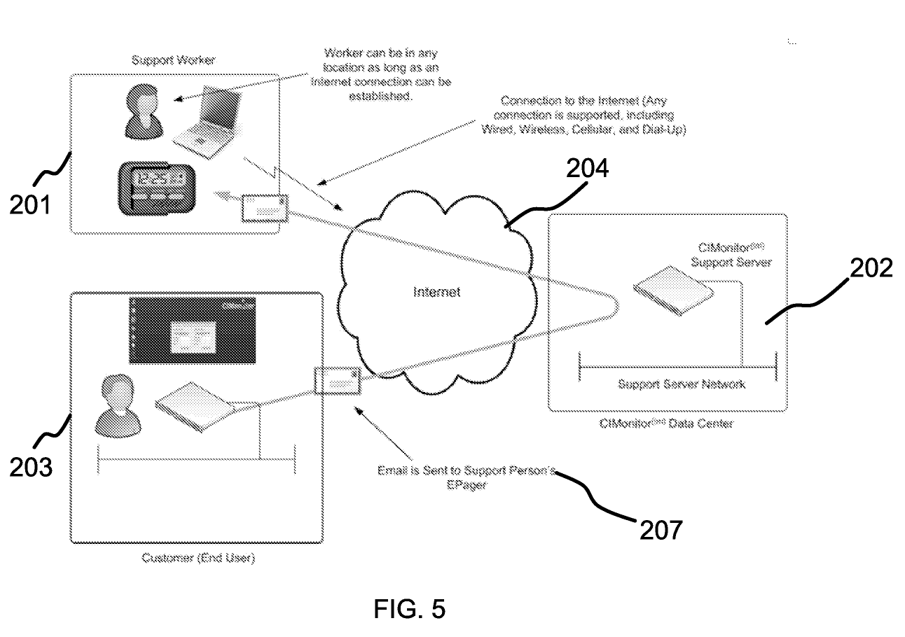

Upon requesting support, the notification may include certain information provided by the end user. FIG. 3 illustrates an example form 301 that is used to request support. Information, such as, user information 301, support information 303, user interface information 304 and emergency information 305 may all be included as part of the information required in the request message 301 of FIG. 3. The information may be automatically converted into an email message 206 and sent to the support worker 201 and/or support server 202 across the Internet 304, as illustrated in FIG. 4. The email may be sent to a support worker in any location geographically provided a communication link is present (see FIG. 5).

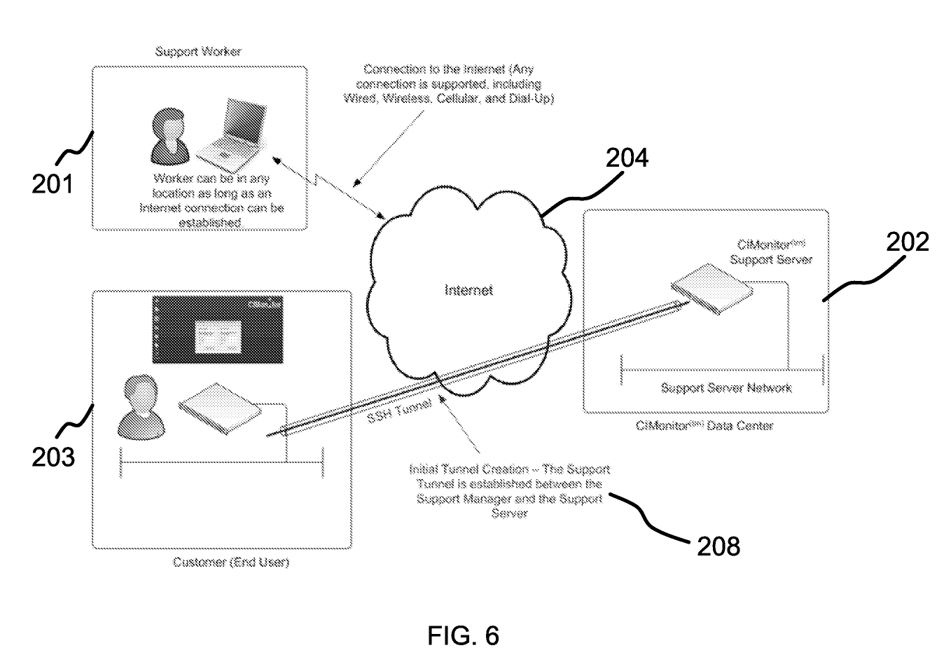

The email message may contain information, such as, the requestor's (customer's) name, phone number and email address, username and password, and port. This information may be determined using previously “fetched” and coordinated information. Once the email is sent, the secure tunnel may be setup. The first part of the tunnel setup requires the support manager application running on the customer end 203 to establish an SSH tunnel with the support server 202, as illustrated in FIG. 6.

Referring to FIG. 6, the support tunnel initiation may be initiated by performing a series of operations. The node manager 102 sets a tunnel initiation request in a file that is read every minute. The request may be simply a one or a zero—if the number one is present, a script is launched to start the tunnel process. If a zero is present, no action is taken, and the file is checked one minute later to see if the file contains a one or zero. The script that launches the tunnel uses previously “fetched” information. The script then resets the tunnel initiation request file back to zero. As a result, the tunnel is initiated at operation 208 of FIG. 6. The support worker 201 is informed of the credentials needed to access the tunnel, either through email or verbally, and the port is opened and becomes available to the support worker 201.

The support worker 201 receives a request and initiates a tunnel. At this point, the support worker 201 can launch a remote desktop connection (Linux or Windows) into the support server 202. Once the support worker 201 receives the support request, they have the credentials needed to log into the customer's support manager 104 and perform maintenance. The support worker 201 launches the support request application from their computer. The application uses the credentials (username, password, and port) to establish the support tunnel. The application can provide one of two options, depending on the support person's requirements. According to option one, a program may be used to establish the tunnel. Such a program could be a freeware program, such as, “plink”, which can be used to establish the tunnel. A menu driven launcher for plink may be provided by CIMonitor™.

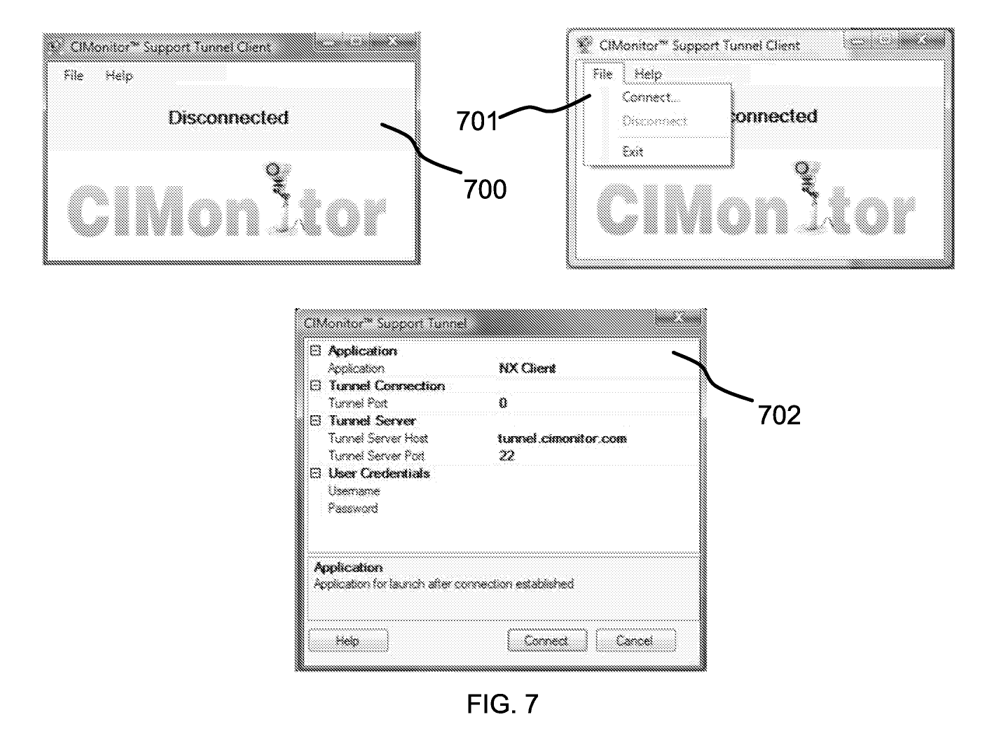

The tunnel launching application may include a request for a username, password, and port information. The CIMonitor™ GUI is used to create the tunnel and launch the GUI interface is illustrated in FIG. 7. Referring to FIG. 7, 700 illustrates a disconnected status. The user may select file—connect and a menu may appear to connect at 701. GUI 702 illustrates a support tunnel launch applet that may be used to identify and launch a tunnel.

As indicated above, the username, password and port information may be entered by the support worker 201. A connection server may also be identified by its IP address as part of the GUI menu. Once the tunnel is established, the GUI client, such as, the NX client or the remote desktop client is automatically launched. At this point, there is a complete, secure, and active tunnel, and support can begin to be provided.

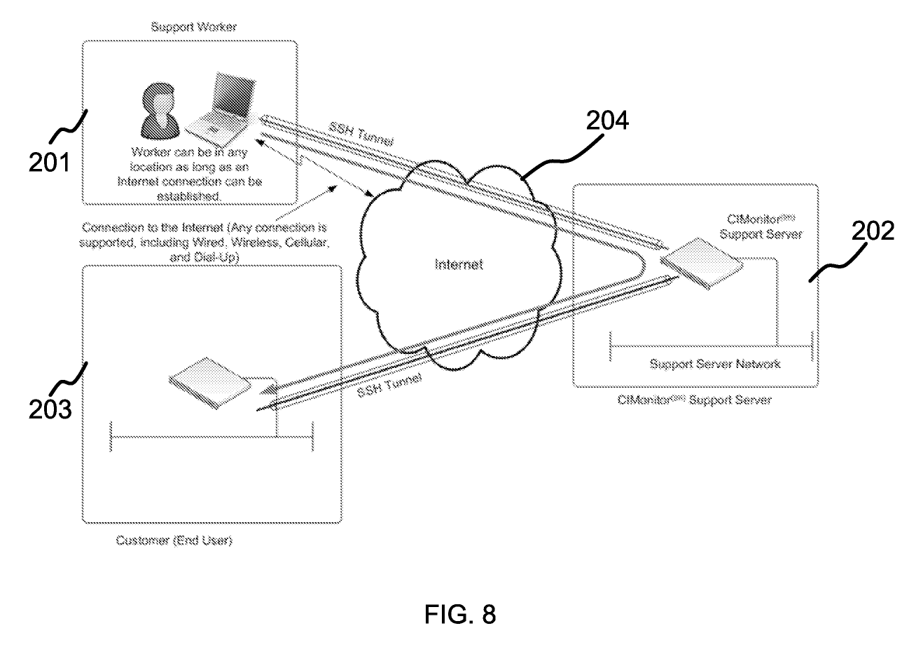

FIG. 8 illustrates the support worker 201 providing support through an established tunnel, according to example embodiments of the present invention. Referring to FIG. 8, a SSH tunnel is established from the support worker 201 to the support server 202. The SSH tunnel is also established between the support server 202 and the end user 203.

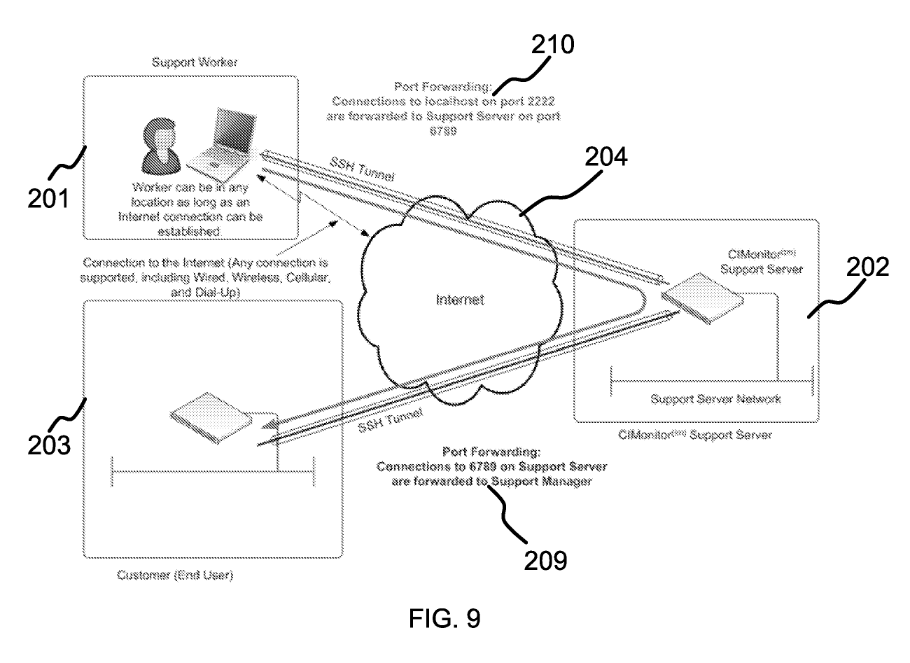

FIG. 9 illustrates additional port forwarding information. For example, the port forwarding connections to port 6789 are forwarded to the support manager 104 at operation 209. The connections to a local host are provided on port 2222 at operation 210. Such connections are forwarded to support server on port 6789. The support manager 104 has established port 6789 as the port to use. The support worker 201 uses this same port to establish the tunnel to the support server 202. Also, the support worker 201 launches the GUI application on their computer utilizing their own internal address (“localhost”, or 127.0.0.1). Every computer has a localhost address of 127.0.0.1. The support application “port forwards” this information to the support manager 104 on port 6789. Once the support work is complete (or any time the customer desires), the customer can terminate the tunnel.

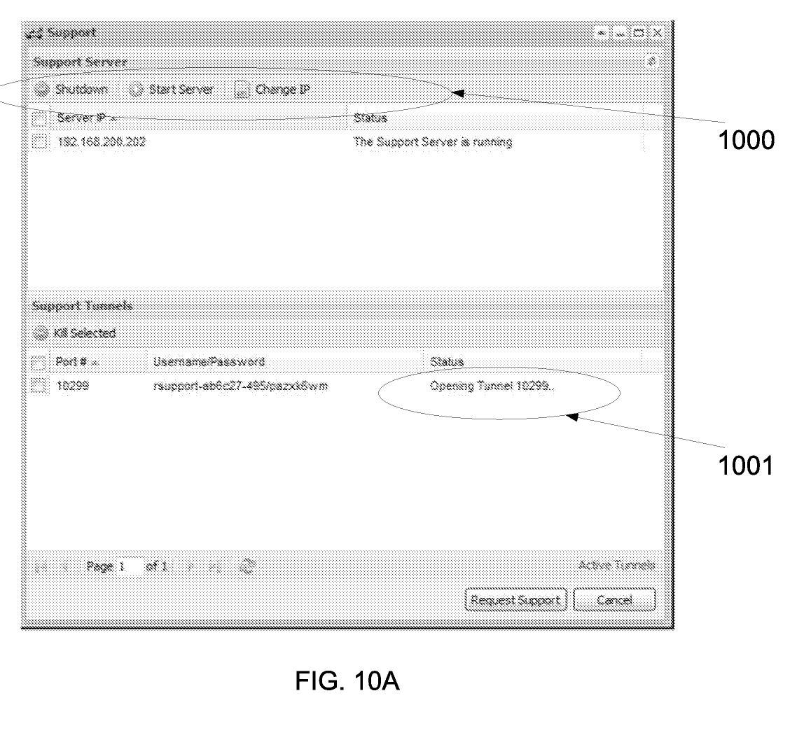

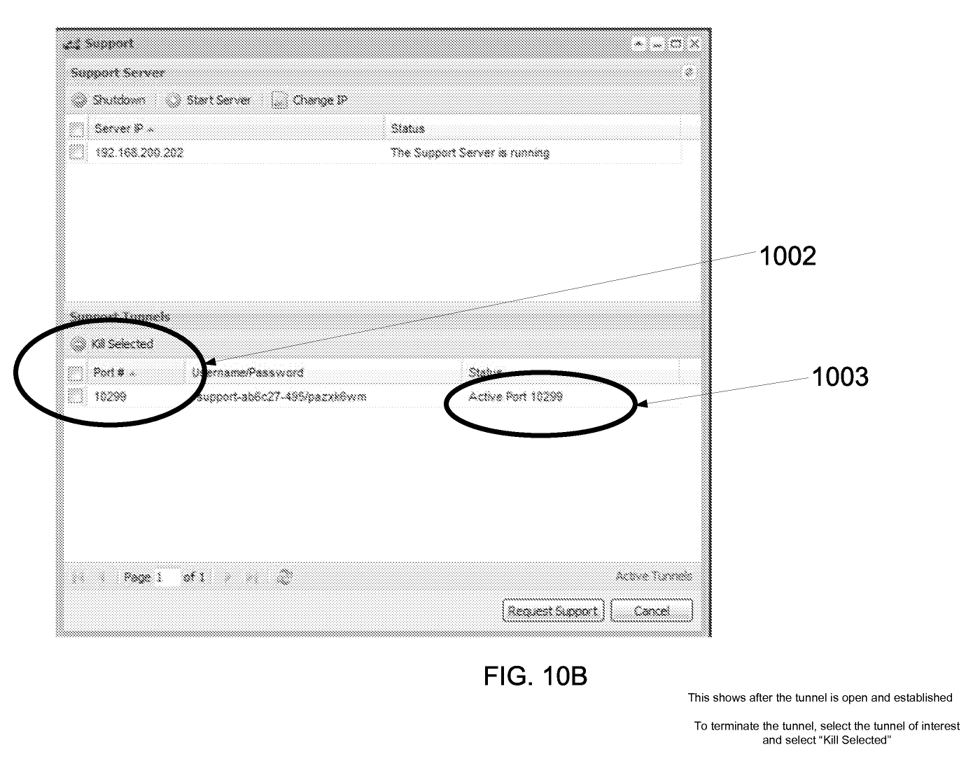

FIG. 10A illustrates an example tunnel access GUI. Referring to FIG. 10A, this interface provides a way to start, stop, or change the IP address of the support manager. The tunnels may be individually selected and terminated at any time. The end user 203 establishes a tunnel by establishing a connection with the support server and opening the tunnel 1001. The user's system is now free from all remote connections, and is operating normally.

FIG. 10B illustrates another example tunnel access GUI. Referring to FIG. 10B, The active port 10299 illustrates that the tunnel is open 1003. Item 1002 illustrates a tunnel selection tab that may be used to select the tunnel to kill the active tunnel. In order to ensure a unique port and password is used for each connection, the support server 106 is configured to provide various functions. The support server 106 is located in a central location and is used by CIMonitor™ customer appliances to provide connectivity for the support tunnel. The functions of the support server 106 may include accepting connections from any CIMonitor™ appliance using a specific, pre-defined username and a public key infrastructure (PKI). The CIMonitor™ appliances are pre-configured with the appropriate cryptographic keys for automated SSH access. Once the connection is established, a program is run on the support manager 104 to allocate a port to use and synchronize the new username/password pair for the support user.

Other functions of the support server 106 may include a CIMonitor™ “Pre-Fetch” operation. The support tunnel accesses the CIMonitor support server 106 as well as the end user's CIMonitor support manager 104. The pre-fetch operation is a term used to describe the process by which the support manager 104 gathers the username, password, and port information for the support tunnel prior to actually using this information. This allows the manager and server to remain in synchronization. Without the ability to pre-fetch, the customer would not be able to provide timely email or verbal notification of the username, password, and port being used. An intermediate server and the CIMonitor™ support server are used to broker connections. Support tunnels may be open automatically, and unique passwords and ports are provided to any support user since the connections can be synchronized.

The pre-fetch feature also allows the end user 203 (the customer) to associate a support worker 201 with a username and port. This enables the end user 203 to know which tunnel to terminate. The process for performing a pre-fetch may include each CIMonitor™ appliance being provided to a customer with a “first-boot” flag set to one. The first boot flag is set in the support manager 104 in a file directory of /root/cimonitor/first_boot. Upon a customer's CIMonitor™ appliance being boot-up for the first time, the support manager 104 may perform a set of operations.

The support manager 104 may generate a number of usernames (the default is five) based on the last four digits of the MAC address of the Ethernet interface. The usernames become a sequential name with the following syntax: rsupport-[index_number][a number of digits of the MAC address such as the last_four_digits_of_MAC_address]-[additional identifier]. For example, if the last four digits of the MAC address are 6c27, the usernames will be rsupport-06c27-491, rsupport-06c27-492, rsupport-06c27-493, rsupport-06c27-494, and rsupport-06c27-495 (see FIG. 10).

The support manager 104 may also save the usernames in the file /root/cimonitor/support_users, and connect to the support server 202 via SSH and copy the file support_users to the /home/cimonitor directory. When these operations are performed, the file name may be changed to include the last four digits of the support manager's MAC Address. Also, the users may be added to the server using the “useradd” program, and a random password for each of the usernames may be generated using a random eight-character generator. The usernames and passwords may be combined in a text file called userpass.txt, which includes the last_four_digits_of_MAC_Address and is stored in the /root/cimonitor directory) using the format username:password.

The support manager 104 may also use the Linux program “chpasswd” to read the text file and change the passwords, set the file “first_boot” to zero, and connect to the support server 106 and perform a secure copy of the userpass.txt file to the /home/cimonitor directory. In response, the support server 106 performs certain operations in response to the files being set by the support manager. For example, the support server 106 uses a task scheduling application called “cron” to check every minute for a new file beginning with “support_users.” When it finds a file matching that criteria, it will extract the usernames and run the “adduser” program on each user, and delete the file.

The support server 106 also uses cron to run the script check_passwords.sh every two minutes. This script looks for a file with the name beginning with userpass.txt and runs the chpasswd program, and deletes the file. A two minute delay is used to ensure that the usernames are created prior to trying to synchronize the passwords. The support server 106 randomizes a username/password combination (there will be five rotating usernames per device and passwords are randomly generated using a custom program). Randomization is performed using a script written to randomize passwords into eight character strings. The script is called “pass_gen.sh” and provides eight randomized characters (alpha, numeric, and meta-characters such as periods and exclamation points).

Once the support manager has generated the usernames and the initial passwords, the information is securely sent to the support server, where ports are allocated for each username/password combination. This information is relayed back to the support manager and is used in the support requests. The five username/password/port combinations are created and stored on the support manager. The support manager 104 establishes an SSH session to the CIMonitor™ support server and requests five ports to be used for the next connections. When the five unique username/password/port combinations are used, a new pre-fetch operation occurs, which ensures that a unique port and username/password pair will be available for future requests. A forced delay timer is used at the support manager before each new pre-fetch operation, ensuring that all devices (support manager and support server) are properly synchronized to avoid any synchronization issues.

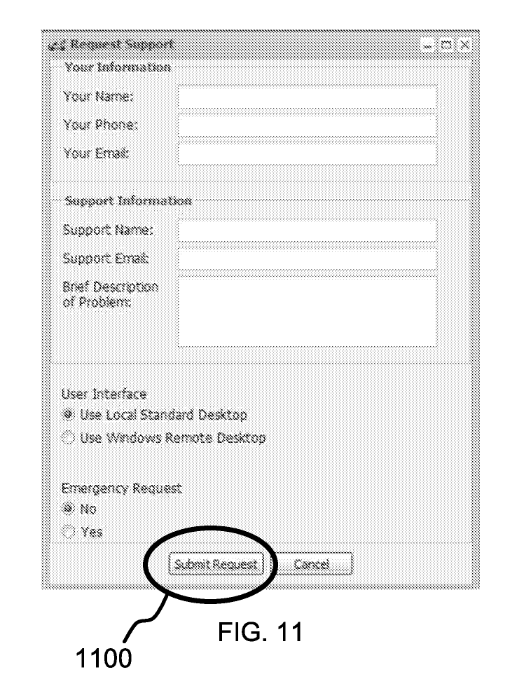

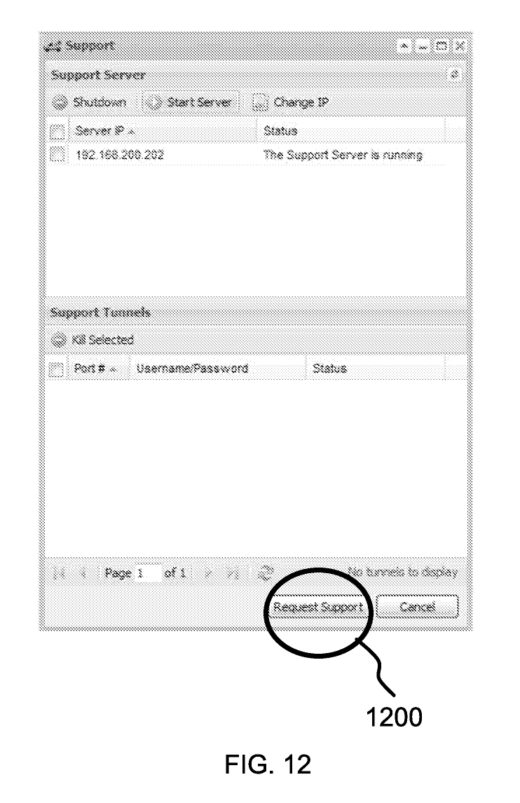

When remote support is needed, the customer 203 can establish the tunnel by logging into the CIMonitor™ appliance and selecting “support” from a desktop icon. Examples of selecting the request support tab, completing the appropriate information, and selecting the “Request Support” buttons 1100 and 1200, are illustrated in FIGS. 11 and 12. Upon selecting a support request, the process of initiating the tunnel is in progress. Within a minute, the tunnel is completed and operational, and is ready to accept a connection from the support personnel.

Once the tunnel is established, the support or emergency responder person can access the device using the port and credentials given. To accomplish this, the support/emergency responder worker uses a SSH client with port-forwarding capabilities. This can be done either using the SSH client provided by CIMonitor™ or the customer can establish a connection with alternatives (such as PuTTY) using instructions, such as, use the username, password and port obtained in the email or provided verbally by the user requesting support, or, use the server's IP address, configure PuTTY to port forward localhost (127.0.0.1) port 2222 to the remote port specified in the email or given verbally.

The Linux KDE Desktop (the default) is a standard Linux desktop environment. For this connection, a Linux desktop client is preferably used. The recommended open-source client is from “No Machine.” Alternatives can be used if they comply with the FreeNX standard. For example, once the VM is loaded, a suitable Windows® OS will be loaded (depending on the then-current version available) and configured for remote desktop support. For this connection, the free Windows® remote desktop application is recommended, although another client like the No Machine client can be used. Alternatively, the communication may be forwarded directly to an (external) remote Windows® Host. This is similar to the internal Windows® client, but requests are forwarded directly to a suitable Windows® host that the end user specifies. For this connection, the free Windows® remote desktop application is recommended, although another client like the No Machine client can be used.

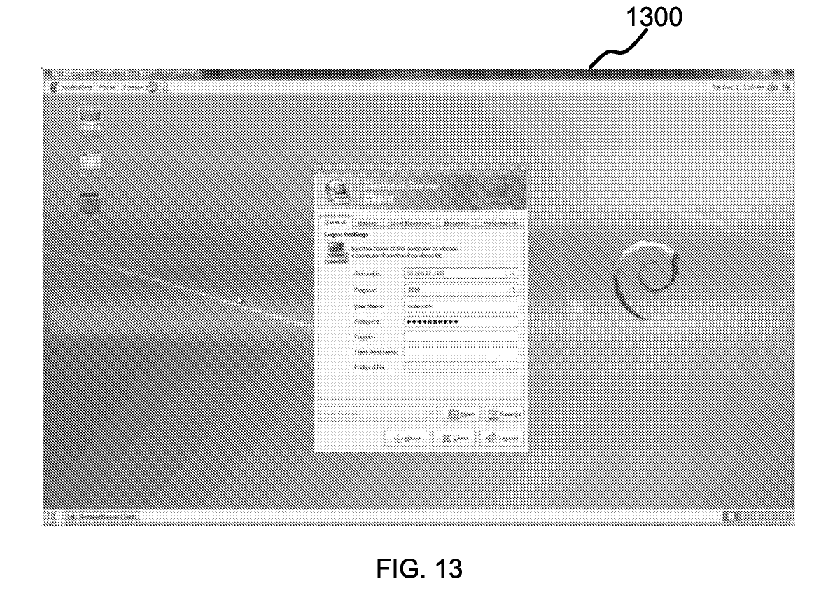

In addition to the SSH client and NX Client, the NX client requires a profile to be established, this profile can be completed easily using instructions on the CIMonitor website or, if the support person installs the CIMonitor™ application, a suitable profile is automatically placed on the support person's computer. Once all of the requisite software has been downloaded and installed, the support tunnel is completed by launching the SSH client, using the username, password, and port given. Note that this port is for the port forwarding, not for the SSH connection port. Once the tunnel is established, the support person can launch the GUI client. The client will connect to the customer's CIMonitor™ support manager 104 and allow access to the support desktop. FIG. 13 illustrates a desktop 1300 with the client application GUI that is used to connect the customer to the support services.

To follow this connection flow in detail, example parameters may be username: cim-support, password: cimonitor, port: 6789. Based on the above parameters, at the support manager side, once the request has been made for remote support, the CIMonitor™ support manager 104 launches a secure shell (SSH) connection to the support server 106/202. An SSH tunnel is established between the support manager 104 and the support server 106. This tunnel sets up a port-forward for all traffic arriving at the support server 106 with the destination port of 6789.

Port forwarding, also referred to as port mapping, is a process for forwarding a network port from one network node to another. In this method, when a connection is established using the port configured for forwarding, it is sent, automatically, to the destined host on the forwarded port. In this example, when a connection is made to the support server 106, all traffic destined to port 6789 is automatically forwarded to the support manager 104. The SSH tunnel is established automatically using public/private keys (using Public Key Infrastructure) established between CIMonitor™ appliance and the CIMonitor™ support server 106. Therefore, no additional login credentials are required to establish the tunnel. SSH authentication supports both public key and username/password authentication methods. Since the same public/private key-pair is used for each CIMonitor™ appliance, no additional authentication is required for login.

At the support emergency responder side, the support worker 201 initiates an SSH connection between their computer and the CIMonitor™ support server 202 with LOCAL port 2222 being forwarded to REMOTE port 6789. In this configuration, any packets destined for the support person's PC on TCP port 2222 will be automatically forwarded to the CIMonitor™ support server 202 on TCP port 6789. Since a port forward is in place between the CIMonitor™ support server 202 and the support manager, packets destined for TCP port 6789 on the support server 202 will be forwarded to the support manager.

The client uses LOCAL port 2222 (i.e., a connection to localhost or 127.0.0.1) to establish a connection to the support manager. This is depicted in the FIG. 9. After support is completed, the customer can terminate the tunnel by selecting the username and port and clicking on the “kill” button. This will immediate terminate the tunnel connection. Alternatively, the end user can kill all connections immediately by shutting down the support manager. This will only affect support tunnels, no other CIMonitor appliance functions are affected. The screen the customer would use to terminate an individual tunnel is illustrated in FIG. 10.

Providing an easy to use graphical interface, to support a remote user allows for a simple support request generation and the ability to kill the support requests. As a result a message or e-mail may be sent to any support person with credentials. Build-up and teardown may be performed on-the-fly. Furthermore, random passwords, ports and rotating usernames, may all be distributed and modified automatically, keeping the system secure. The ports may not be randomly generated, as they are sequentially generated. However, multiple support managers might each be requesting ports. For example, manager 1 might receive ports 10455-10459, manager 2 10460-10464, and so on. In the event that manager 1 needs to get additional ports, the support server allocates 11022-11026. So, the ports are sequentially generated by the support server but distributed to each support manager on a first-come, first-served basis. This provides a pseudo-random port generation. Regardless, ports are not reused until they are exhausted at around 65000. However, the chances of someone getting the same port for the same appliance is very small, and with rotating usernames and one-time passwords such a conflict is not feasible.

Since the support manager at the end user's site never directly communicates with the Internet (it just communicates with the CIMonitor™ support manager), it never has exposed ports to the Internet. All communication is encrypted using 3DES, and the random passwords and ports make the connection secure. This provides a separate work environment, no screen sharing techniques which force the end user to tie-up their desktop or wait around while their screen is being manipulated remotely.

As described above, methods of operation include deploying, creating, establishing, and terminating support tunnels on the CIMonitor™ appliance. This provides a secure, robust way to provide support or emergency responder interaction in a separate, secure, desktop environment. It can scale to thousands of tunnels world-wide. Tunnels are created and terminated by the end-user, providing complete control of the support request.

The operations of a method or algorithm described in connection with the embodiments disclosed herein may be embodied directly in hardware, in a computer program executed by a processor, or in a combination of the two. A computer program may be embodied on a computer readable medium, such as a storage medium. For example, a computer program may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

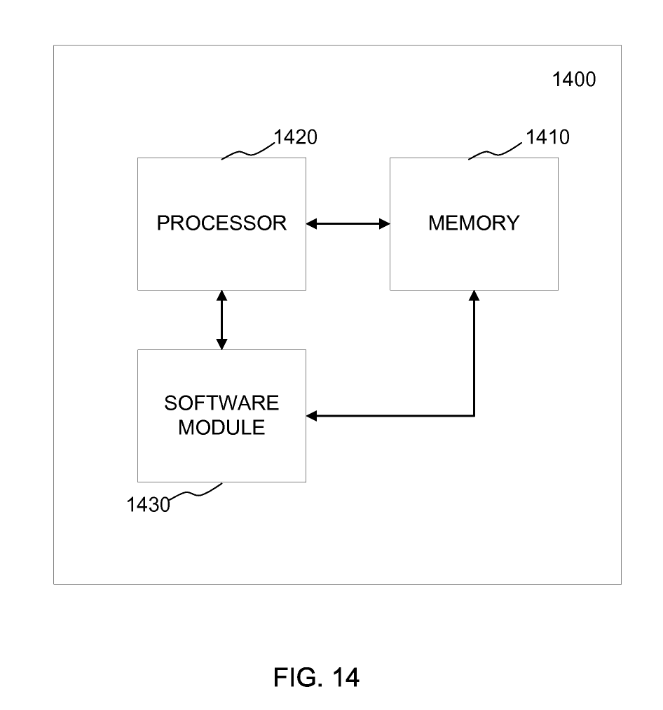

An exemplary storage medium may be coupled to the processor such that the processor may read information from, and write information to, the storage medium. In the alternative, the storage medium may be integral to the processor. The processor and the storage medium may reside in an application specific integrated circuit (“ASIC”). In the alternative, the processor and the storage medium may reside as discrete components. For example FIG. 14 illustrates an example network element 1400, which may represent any of the above-described network components 100-106 and 201-204.

As illustrated in FIG. 14, a memory 1410 and a processor 1420 may be discrete components of the network entity 1400 that are used to execute an application or set of operations. The application may be coded in software in a computer language understood by the processor 1420, and stored in a computer readable medium, such as, the memory 1410. The computer readable medium may be a non-transitory computer readable medium that includes tangible hardware components in addition to software stored in memory. Furthermore, a software module 1430 may be another discrete entity that is part of the network entity 1400, and which contains software instructions that may be executed by the processor 1420. In addition to the above noted components of the network entity 1400, the network entity 1400 may also have a transmitter and receiver pair configured to receive and transmit communication signals (not shown).

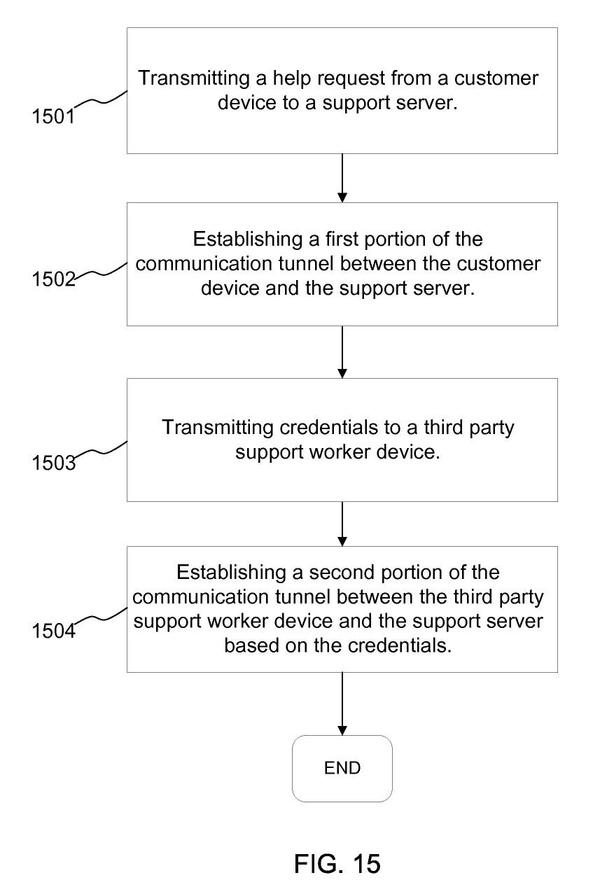

One example method according to example embodiments of the present invention may include a method of establishing a communication tunnel to provide customer support, as illustrated in FIG. 15. The method may include transmitting a help request from a customer device to a support server, at operation 1501. The method may also include establishing a first portion of the communication tunnel between the customer device and the support server, at operation 1502. The method may further include transmitting credentials to a third party support worker device, at operation 1503 and establishing a second portion of the communication tunnel between the third party support worker device and the support server based on the credentials, at operation 1504.

While preferred embodiments of the present invention have been described, it is to be understood that the embodiments described are illustrative only and the scope of the invention is to be defined solely by the appended claims when considered with a full range of equivalents and modifications (e.g., protocols, hardware devices, software platforms etc.) thereto.

What is claimed is:

1. A method of establishing a communication tunnel to provide customer support, the method comprising:
transmitting a help request from a customer device to a support server;
establishing a first portion of the communication tunnel between the customer device and the support server;
transmitting credentials to a third party support worker device; and
establishing a second portion of the communication tunnel between the third party support worker device and the support server based on the credentials.

2. The method of claim 1, wherein the credentials comprise at least one of a username, password and port address.

3. The method of claim 1, further comprising:
resetting a tunnel initiation file to zero after the first and second portions of the tunnel have been established.

4. The method of claim 1, wherein the help request is an email message that is automatically generated.

5. The method of claim 1, wherein establishing the first portion of the communication tunnel comprises a support manager application operating on the customer device establishing a secure shell (SSH) tunnel with the support server.

6. The method of claim 1, wherein the help request includes at least one of personal user information, support information and user interface information.

7. The method of claim 1, wherein at least one of the personal information, support information and user interface information is pre-fetched.

8. An apparatus configured to establish a communication tunnel to provide customer support, the apparatus comprising:
a transceiver configured to receive a help request from a customer device and forward the help request and customer credentials to a third party worker device; and
a processor configured to establish a first portion of the communication tunnel to the customer device and to establish a second portion of the communication tunnel to the third party support worker device based on the credentials.

9. The apparatus of claim 8, wherein the customer credentials comprise at least one of a username, password and port address.

10. The apparatus of claim 8, wherein the processor is further configured to reset a tunnel initiation file to zero after the first and second portions of the tunnel have been established.

11. The apparatus of claim 8, wherein the help request is an email message that is automatically generated.

12. The apparatus of claim 8, wherein the first portion of the communication tunnel is established by a support manager application operating on the customer device, which establishes a secure shell (SSH) tunnel with the apparatus.

13. The apparatus of claim 8, wherein the help request includes at least one of personal user information, support information and user interface information.

14. The apparatus of claim 8, wherein at least one of the personal information, support information and user interface information is pre-fetched.

15. A non-transitory computer readable storage medium comprising instructions that when executed by a processor cause the processor to perform establishing a communication tunnel to provide customer support, the processor being further configured to perform:
transmitting a help request from a customer device to a support server;
establishing a first portion of the communication tunnel between the customer device and the support server;
transmitting credentials to a third party support worker device; and
establishing a second portion of the communication tunnel between the third party support worker device and the support server based on the credentials.

16. The non-transitory computer readable storage medium of claim 15, wherein the credentials comprise at least one of a username, password and port address.

17. The non-transitory computer readable storage medium of claim 15, wherein the processor is further configured to perform:
resetting a tunnel initiation file to zero after the first and second portions of the tunnel have been established.

18. The non-transitory computer readable storage medium of claim 15, wherein the help request is an email message that is automatically generated.

19. The non-transitory computer readable storage medium of claim 15, wherein establishing the first portion of the communication tunnel comprises a support manager application operating on the customer device establishing a secure shell (SSH) tunnel with the support server.

20. The non-transitory computer readable storage medium of claim 15, wherein the help request includes at least one of personal user information, support information and user interface information.
